(19) United States
(12) Patent Application Publication
(10) Pub. No.: US 2009/0045166 A1
(43) Pub. Date: Feb. 19, 2009

(54) METHOD OF ENHANCING BIOCOMPATIBILITY OF ELASTOMERIC MATERIALS BY MICROTEXTURING USING MICRODROPLET PATTERNING

(76) Inventor: Yangyang Li, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/093,272

(22) PCT Filed: Nov. 9, 2006
(86) PCT No.: PCT/US2006/043823

§ 371 Date: May 9, 2008

(51) Int. Cl. B44C 1/22

(52) U.S. Cl. 216/49

(57) ABSTRACT

A simple method to introduce microstructures to the surface of elastomeric materials such as silicone elastomers is described. The patterns are generated by forming microdroplets of a protective polymer onto a silicone elastomer film, hardening the polymer, and then removing the uncoated material by chemical etching. Cell attachment study results show that the treated material has a significantly enhanced biocompatibility compared to a non-treated control.

### BACKGROUND OF THE INVENTION

1. Field of the Invention

A simple method to introduce microstructures to the surface of elastomeric materials such as silicone elastomers or rubbers is described. The patterns are generated by forming microdroplets of a protective polymer on an elastomeric film, hardening the polymer, and then removing the uncoated material by chemical etching. Cell attachment study results show that the treated material has a significantly enhanced biocompatibility compared to a non-treated control.

2. Description of the Related Art

Elastomeric materials, such as silicone elastomers or rubbers, have been widely exploited for a variety of medical device applications. Silicone elastomers and silicone rubbers are types of silicone polymers. Specifically, these are any of a group of semi-inorganic polymers that are based on the structural unit R₂SiO, where R is an organic group. Efforts towards optimized performance of devices comprising elastomeric materials such as silicone elastomers or rubbers mainly focus on two usually compatible approaches: chemistry modification (see Wang et al., Nature Biotechnology 20:602-606 (2002); Hu et al., Langmuir 20:5569-5574 (2004); Chen et al., Biomaterials 25:2273-2282 (2005); Makamba et al., Anal. Chem. 77:3971-3978 (2005); Price et al., J. Biomed. Mater. Res. 74B:481-487 (2005); Huang et al., Lab Chip 5:1005-1007 (2005); Yamauchi et al., Macromolecules 38:8022-8027 (2005); and Zhou et al., Colloids and Surfaces B:Biointerfaces 41:55-62 (2005)) and surface topography modification (see Yamauchi et al., Macromolecules 38:8022-8027 (2005); den Braber, et al., Biomaterials 17:2037-2044 (1996); Flemming et al., Biomaterials 20:573-588 (1999); Wilkerson et al., Polymer Preprints 42:147-148 (2001); Berglin et al., Colloids and Surfaces B:Biointerfaces 28:107-117 (2003); Evans et al., Biomaterials 26:1703-1711 (2005); and Goldner et al., Biomaterials 27:460-472 (2006)). One common method for chemistry modification of silicone elastomers is plasma treatment: for example, Price et al., supra, subjected silicone rubber to a combination of argon plasma discharge treatment and fluorinated silane coupling and found reduced Candida adherence to the treated rubber. Another known method is polymer grafting: for example, Hu et al, supra, co-mixed charged and neutral monomers in creating polydimethylsiloxanes (PDMS) with different electrophoretic mobility properties; Zhou et al, supra, grafted N,N′-dimethyl-N-methacryloyloxyethyl-N-(2-carboxyethyl) ammonium onto silicone rubber film and found that the film so treated had improved blood compatibility, as indicated by no platelet adhesion and reduced protein absorption; and Xiao et al., Anal. Chem. 76:2055-2061 (2004), modified PDMS surfaces with polyacrylamide through atom-transfer radical polymerization and found that the use of such surfaces in capillary structures eliminated protein adsorption and facilitated electrophoretic protein separation. Another known chemical modification method is adsorption: for example, Huang et al., supra, coated PDMS with n-dodecyl-β-D-maltoside, thus minimizing nonspecific protein adsorption, and Phillips et al., Anal. Chem. 77:327-334 (2005), assembled phosphatidylcholine membranes on plasma-oxidized PDMS to improve wettability and protein resistance. General classes of modification methods of PDMS include energy exposure, dynamic modification using charged surfactants, modification using polyelectrolyte multilayers, covalent modification including radiation-induced graft polymerization and Cerium (IV)-catalyzed polymerization and silanization, chemical vapor deposition, phospholipid bilayer modification, and protein modification, as reviewed in Makamba et al., Electrophoresis 24:3607-3619 (2003). These modifications facilitate desired device behaviors related to protein attachment (see Chen et al., supra), cellular response (see Makamba et al., Anal. Chem., supra) and adhesion (see Bartzoka et al., Adv. Mater. 11:257-259 (1999)). Surface topography of silicone elastomers is typically modified by micro-patterning techniques. Many studies have shown a distinct difference in bioadhesion on textured surfaces compared to their conventional counterparts. Examples include Flemming et al., supra (relating basement membrane topology to effects of synthetic micro- and nano-structured surfaces on cell alignment and layer formation); Goldner, et al., supra (observing bridging of neurites between grooves of a grooved PDMS surface); den Braber et al., J. Biomed. Mater. Res. 15:539-547 (1997) (finding significantly fewer inflammatory cells and more blood vessels in the capsules surrounding microgrooved silicone rubber implants in vivo); Yim et al., Biomaterials 26:5405-5413 (2005) (finding that smooth muscle cells seeded on elastomeric surfaces with nanopatterned gratings aligned to the gratings and were elongated in comparison with cells seeded on control surfaces); Thapa et al., Biomaterials 24:2915-2926 (2003) (finding that bladder smooth muscle cells were present in greater numbers on chemically etched polymeric films as the surface roughness of the nanostructures increased); and von Recum et al., J. Biomater. Sci., Polym. Ed. 7:181-198 (1995).

Several methods have been described to produce micro-structured surfaces, typically using micro-machining technology, such as the generation of a pattern on the surface using photolithography followed by reactive ion etching, or the casting of a mixture of siloxane resin and its curing agent on the pre-patterned master followed by peeling off the cured elastomer (soft-lithography). Both of these methods provide precise control of the surface features, but are usually limited to flat device surfaces or uncured materials, respectively. Furthermore, observations of surface rearrangements of silicone elastomers (specifically, polydimethylsiloxane, “PDMS”) have been reported, although this phenomena has not been fully addressed to date. For example, Makamba et al., Anal. Chem., supra, reported the phenomenon of surface rearrangement of hydrophilically modified PDMS (which is highly hydrophobic in its unmodified form), causing a reversion of the surface back to a hydrophobic state, and Batra et al., Macromolecules 38:7174-7180 (2005), reported the effects of end-linking of PDMS chains on the terminal relaxation time of the elastomer. These observations of the rearrangement of microstructures introduced to the surfaces of elastomeric materials, with the attendant loss of the desirable properties those microfeatures bring, indicates that the surface of elastomeric materials such as silicone elastomers is often unstable over time, and that this instability may eliminate the benefits achieved by surface modification.

### SUMMARY OF THE INVENTION

In an aspect of the present invention, a method of treating an elastomeric surface is provided which comprises: forming microdroplets of a liquid comprising a polymer on the elastomeric surface; hardening the polymer microdroplets; chemically etching the surface with an agent that etches the elastomer but does not etch the hardened polymer microdroplets; and dissolving the polymer microdroplets.

In a further aspect, the elastomeric surface comprises a silicone elastomer.

In a further aspect, the elastomeric surface comprises polydimethylsiloxane.

In a further aspect, the liquid comprises polymers dissolved in propylene glycol monomethyl ether acetate.

In a further aspect, the forming step comprises spraying the liquid onto the elastomeric surface.

In a further aspect, the forming step comprises bringing an elongate probe that supplies the liquid into contact with the elastomeric surface.

In a further aspect, the hardening step comprises baking.

In a further aspect, the hardening step comprises exposing the microdroplets to radiation.

In a further aspect, the hardened microdroplets have a maximum width within a range of 0.001-500 microns.

In a further aspect, the hardened microdroplets have a maximum width within a range of 0.005-300 microns.

In a further aspect, the hardened microdroplets have a maximum width within a range of 0.05-175 microns.

In a further aspect, the hardened microdroplets have a maximum width within a range of 0.5-100 microns.

In a further aspect, the etching agent is an acid solution.

In a further aspect, the acid solution is an aqueous hydrofluoric acid solution.

In a further aspect, the acid solution is a nitric acid solution.

In a further aspect, the etching agent is an ionic species.

In a further aspect, the etching agent is oxygen plasma.

In a further aspect, the etching agent is selected from the group consisting of sodium hydroxide, acetone, toluene, and hexane.

In a further aspect, the dissolving step comprises rinsing with an agent that dissolves the polymer microdroplets.

In a further aspect, the rinsing agent is ethanol.

In a further aspect, the rinsing comprises ultrasonication in absolute ethanol.

In a further aspect, the method additionally comprises rinsing the surface with water immediately after the etching step.

In a further aspect, the forming step comprises spraying the polymer solution onto the elastomeric surface through a shadow mask.

In a further aspect, the shadow mask has a grid shape.

In a further aspect, the shadow mask is configured to prevent formation of microdroplets on at least a portion of the elastomeric surface.

In a further aspect, the forming step comprises heating solid polymer microparticles to form the polymer microdroplets.

In a further aspect, the hardening step comprises cooling the microdroplets.

### BRIEF DESCRIPTION OF THE DRAWINGS

FIG. 1 shows the method of forming microstructures on elastomeric films of the present disclosure in schematic form.

FIG. 2(a) shows a scanning electron micrograph of a control PDMS film.

FIG. 2(b) shows a scanning electron micrograph of a PDMS film that was treated in accordance with the present method.

FIG. 3(a) shows a bright field photographic image, taken 68 days after treatment, of a control PDMS film that was etched for 60 minutes but which was not sprayed with polymer microdroplets.

FIG. 3(b) shows a bright field photographic image, taken 68 days after treatment, of a PDMS film that was etched for 60 minutes after being sprayed with polymer microdroplets.

FIG. 3(c) shows a bright field photographic image, taken 68 days after treatment, of a control PDMS film that was etched for 2 minutes but which was not sprayed with polymer microdroplets.

FIG. 3(d) shows a bright field photographic image, taken 68 days after treatment, of a PDMS film that was etched for 2 minutes after being sprayed with polymer microdroplets.

FIG. 4(a) shows a bright field photographic image of a control PDMS film that was not subjected to etching and was subsequently exposed to HEK cells in a cell attachment test.

FIG. 4(b) shows a fluorescence image of the control PDMS film of FIG. 4(a).

FIG. 4(c) shows a bright field photographic image of a PDMS film that was subjected to etching and was subsequently exposed to HEK cells in a cell attachment test.

FIG. 4(d) shows a fluorescence image of the treated PDMS film of FIG. 4(c).

FIG. 5(a) shows a bright field photographic image of a silicone tube before treatment using the method of the present disclosure.

FIG. 5(b) shows a bright field photographic image of the silicone tube after treatment using the method of the present disclosure.

FIG. 6 shows a bright field photographic image of a film treated using the method of the present disclosure together with a grid shadow mask.

### DETAILED DESCRIPTION OF THE PREFERRED EMBODIMENT

The present disclosure relates to the production of textured elastomeric surfaces, such as silicone elastomer surfaces, by spray-coating the silicone film with a fine mist of a polymer-containing liquid, followed by a chemical treatment to etch the uncoated silicone. Examples of the polymer-containing liquid include polymer solutions and suspensions of solid polymer microparticles. After stripping the polymer droplets, a micro-structured surface with micro-island features results. The resulting material has a significantly enhanced cellular adhesion compared to its non-treated counterpart, as shown by cell attachment studies (see Embodiment 3 below).

The method of this disclosure represents a variation of soft-lithography (see Xia et al., Angew. Chem. Int. Ed. 37:550-575 (1998)) that does not require a pre-patterned master (see Li et al., Adv. Mater. 17:1249-1250 (2005)). It is derived from techniques based on ink-jet printing or nozzle spraying that have been used to control the size of micron-sized and smaller particles (see Okuyama et al., Chem. Engr. Sci. 58:537-547 (2003)). The process may be summarized as follows.

First, microdroplets of a polymer are deposited onto an elastomeric surface. In a preferred embodiment, the deposition of the microdroplets may be accomplished by spray deposition using a commercially available sprayer such as a paint sprayer, but any method that results in a random dispersal of polymer microdroplets may be employed. Other spraying devices may be employed, such as pressurized aerosol generators. Preferably, the spraying device employed may be used to produce different-sized microdroplets, via an adjustable nozzle or the like. This is particularly preferable when the elastomeric surface is to be treated a number of times to generate more complicated microstructures. Methods other than spraying may also be employed. For example, in one embodiment the microdroplets may be applied to the elastomeric surface using an elongate probe that comes into contact with the elastomeric surface and supplies a polymer-containing liquid to the surface. Examples of the elongate probe include needles, sticks or other elongate structures that are dipped in the polymer-containing liquid, as well as catheter-like structures through which the polymer solution is supplied. In other embodiments, solid polymer microparticles could be applied to the elastomeric surface and then melted onto the surface in a subsequent heating step. In an aspect thereof, the application of the microparticles is accomplished by entraining the microparticles in a flow of gas that is directed onto the elastomeric surface. In a further aspect, the polymer microparticles are applied by coating the elastomeric surface with a suspension solution containing the microparticles. Alternatively, a polymer vapor may be allowed to condense and form microdroplets on the elastomeric surface. In other embodiments, a polymer-containing liquid may be applied to the elastomeric surface, which is then agitated to allow part of the liquid to run off the surface, with some droplets or other polymer structures remaining thereon. Furthermore, in this context “microdroplets” means droplets that preferably have a maximum width within a range of 0.001-500 microns, more preferably 0.0025-400 microns, even more preferably 0.005-300 microns, even more preferably 0.01-250 microns, even more preferably 0.025-200 microns, even more preferably 0.05-175 microns, even more preferably 0.1-150 microns, even more preferably 0.25-125 microns, and most preferably 0.5-100 microns. Combinations of any of the lower and upper ends of the ranges set forth above are specifically contemplated within the scope of this disclosure. The microdroplets need not have a generally circular configuration; in embodiments the droplets may have oblong or irregularly shaped cross-sections at the point of contact with the elastomeric surface, depending on the content of the microdroplets and the method used to form them.

Furthermore, the treatment of various types of elastomeric materials is contemplated. In preferred embodiments, the silicone elastomer PDMS is employed. However, other dimethyl silicones, methyl phenyl silicones, fluorosilicones, thermoplastic silicone-urethane copolymers, poly(methyl methacrylate), poly(lactic-co-glycolic acid), polyisoprenes, polybutadienes, polychloroprenes, polyisobutylenes, poly (styrene-butadiene-styrene), and polyurethanes such as poly(ether urethane) may also be employed.

Furthermore, the polymer of which the microdroplets are comprised is not particularly limited, so long as it is sprayable in a liquid solution or suspension and may be hardened by baking or some other method. In a preferred embodiment, a solution of polymers in propylene glycol monomethyl ether acetate (commercially available as Shipley 1813) is employed; this solution features ease of use, as it can be conveniently applied, does not dissolve in a water solution, and the resulting hardened microdroplets can be easily removed by ethanol or acetone. Polystyrene and poly(methyl methacrylate) also feature similar ease of use and are also preferred in the present method. However, other polymer solutions may be employed, such as polyurethane, polyester, and the like. Furthermore, any known solvent may be employed so long as it permits hardening of the polymer microdroplets.

The polymer microdroplets act as etch masks. The microdroplets are first hardened, preferably by baking or drying, but any known hardening method may be employed. For example, in some embodiments the microdroplets may be cured by exposure to radiation, such as UV light, or a developing agent. Next, the elastomeric surface with hardened polymer microdroplets thereon is exposed to a chemical etching agent. In preferred embodiments, the etching agent is an aqueous solution of hydrofluoric acid, but any agent known to etch the relevant elastomeric surfaces may be employed. For example, the etching may be accomplished with tetrabutyl ammonium fluoride in THF solution, ion milling, nitric acid, sodium hydroxide, acetone, toluene, hexane, oxygen plasma, or CF₄ gas. Ion milling is a process applied to a sample under vacuum, whereby a selected area of the surface is bombarded by an energetic beam of ions. For example, after selectively covering the elastomer surface with protective polymer microdroplets, ion milling can be performed with argon to remove the unprotected elastomer and thus to create patterns. The chemical treatment etches away the uncoated elastomer and generates micro-structured features on the uncoated surface. After removing the polymer droplets, a micro-structured surface with micro-island features is obtained. This microdroplet-coating/chemical etching method represents a simple and inexpensive technique to introduce micro-textures to elastomeric device surfaces. A comparison of the conventional micro-processing techniques with the microdroplet patterning technique of the present disclosure is listed in Table 1.

TABLE 1
Comparison of the conventional micro-processing techniques with microdroplet
patterning technique.

| | Photolithography or | | Microdroplet |
|---|---|---|---|
| Technique | ebeam-lithography | Soft lithography | patterning |
| Is a mask or master | Photomask needed for | Master or mold needed | No |
| needed? | photolithography, SEM | | |
| | needed to generate | | |
| | pattern for ebeam | | |
| | lithography | | |
| Typical equipment | Clean room with | Clean room usually | Sprayer or other simple |
| required | Spin coater, Mask | required to generate | mechanical application |
| | aligner or SEM, Iron | master | device |
| | Reactive Etching, etc. | | |
| Applicable to non- | No. | No. | Yes |
| flat surface? | Limited to light-of-sight | Can be only applied to | |
| | effect | uncured materials | |
| Features patterned | Micron or sub-micro | Micron size features, | Micron size particles, |
| | size features, pattern | pattern precisely | randomly located, |
| | precisely controlled. | controlled. | particle size and |
| | | | density adjustable. |
| Compatibility with | Complicated, multiple | Cannot be applied to | Yes |
| mass production | steps, expensive | products already made | |
| | facilities needed | | |

### Embodiment 1

### Formation of Micro-Textured Film

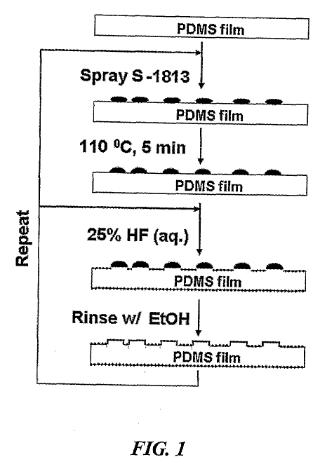

Preparation of the micro-textured silicone elastomers follows the protocol set forth in FIG. 1. PDMS film was prepared using Dow Corning Sylgard® 184 Silicone Elastomer Kit. Specifically, PDMS films were prepared by mixing Dow Corning Sylgard® 184 silicone elastomer with the curing agent in a ratio of 10:1. The mixture was vacuumed and cured at 90° C. for 1 hour. The use of this kit is only exemplary; any known method of producing a PDMS film may be employed. A fine mist of Shipley 1813 solution (Microchem Corp.) was sprayed onto the PDMS film using a commercial portable paint sprayer (Preval® Spray Gun) followed by a hard baking at 110° C. for 5 minutes. These steps formed a pattern of hardened microdroplets on the PDMS surface. The resulting film was exposed to an aqueous 25% solution of hydrofluoric acid (HF) for 10 minutes to etch the uncoated PDMS film. This was followed by a water rinse. To remove the microdroplets of Shipley 1813, the sample was ultrasonicated in absolute ethanol (Aldrich Chemicals) for 15 min and rinsed with ethanol several times. In the present embodiment, the procedures described above were not repeated, but where a greater degree of surface roughness is desired they may be repeated as many times as desired. The effect of repetition of the steps described above will be to increase the complexity of the microstructures formed and thus to increase the surface roughness.

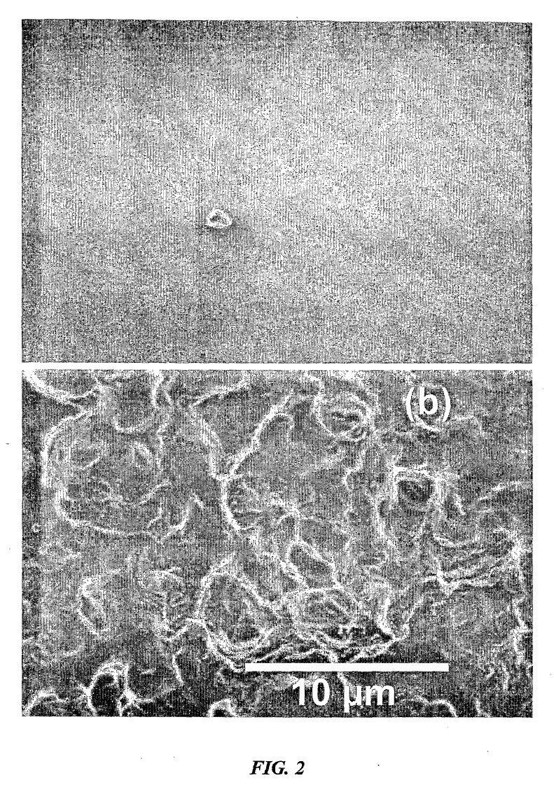

The resulting film had a micro-structured surface, as revealed by scanning electron microscopy. FIG. 2 shows scanning electron micrograph (secondary electron) images of two PDMS films, one obtained by following the spraying, baking, and etching procedures of the present embodiment described above, and one obtained without performing these procedures. FIG. 2(a) shows a non-etched PDMS film, while FIG. 2(b) shows a PDMS film sprayed and etched in 25% aqueous HF solution for 10 minutes. The scanning electron microscope images were obtained using a Hitachi 4800 instrument operating at an accelerating voltage of 1 kV. As can be seen from FIG. 2, the PDMS film that was treated by spraying, baking and etching had microstructures formed on the surface thereof.

### Embodiment 2

### Comparative PDMS Treatment

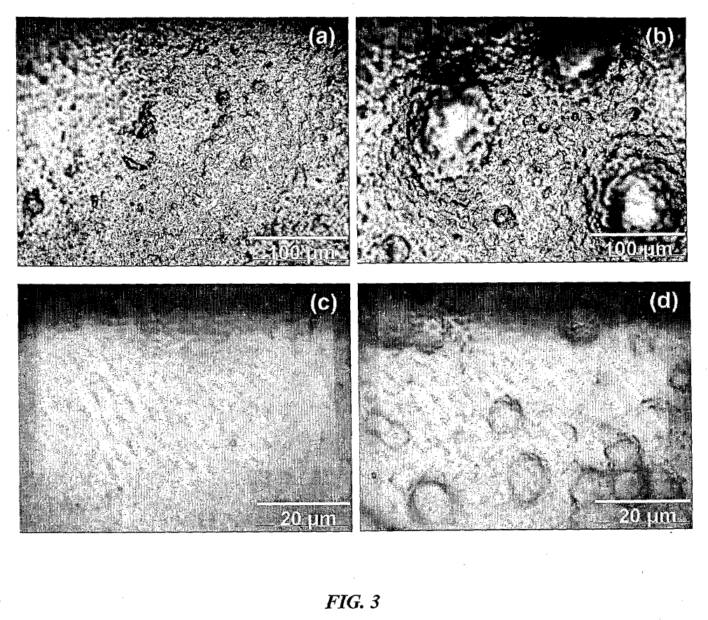

To assess the effects of various treatment protocols on the surface of a PDMS film, sample films were subjected to the following treatments: (a) baking at 110° C. for 5 minutes, followed by etching in 25% aqueous HF for 60 minutes; (b) spraying with polymer solution, baking at 110° C. for 5 minutes, followed by etching in 25% aqueous HF for 60 minutes; (c) baking at 110° C. for 5 minutes, followed by etching in 25% aqueous HF for 2 minutes; and (d) spraying with polymer solution, baking at 110° C. for 5 minutes, followed by etching in 25% aqueous HF for 2 minutes. The protocols described above were employed. Bright field photographs of the resultant PDMS film surfaces (using reflected light) taken 68 days after preparation are shown in FIGS. 3(a)-3(d). As shown in the Figures, samples prepared with both the spraying and etching steps showed increased stability, with micro-structures persisting on the surface after 68 days, comparing to ones prepared identically but without the spraying step. The micro-island features resulting from the spraying step thus not only introduce microstructures to the surface but also serve to stabilize the surface morphology introduced by the etching process.

### Embodiment 3

### Cell Attachment

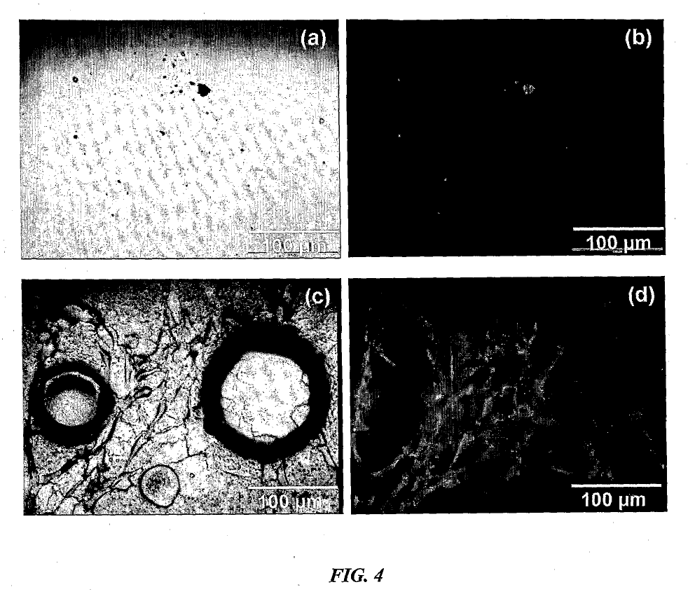

To assess the ability of cells to adhere to both treated and untreated PDMS films as a measure of increased biocompatibility, HEK 293 cells (ATCC, CRL-1573™) were employed in a cell attachment test on the films. This cell line was chosen for ease of use and because it is often employed in assessing cell adhesion to various substrates. Examples of the use of HEK cells in this way can be found in Cui et al., Toxicology Lett. 155:73-85 (2005) (exposing single wall carbon nanotubes to HEK cells to assess biocompatibility of the nanotubes); Gumpenberger, et al., Lasers and Electro-Optics:CLEO/Pacific Rim 1434-1435 (2005) (seeding HEK cells onto a surface-modified polytetrafluoroethylene to assess cell adhesion); and Li et al., Pharmaceutical Research, 20:884-888 (2003) (exposing HEK cells to block copolymyers to assess cytotoxicity thereof). HEK cells were suspended at a concentration of 56,000 cells/ml in Dulbecco's Modified Eagle Media (Invitrogen) with 10% Fetal Bovine Serum (Invitrogen). PDMS films were precut to 0.9 cm by 0.9 cm squares and attached to the well bottom of the cell culture plate (Costar Corp., 24 Well Cell Culture Cluster). 1 ml of HEK cell suspension was added to each well. After incubation at 37° C. for 6 days, HEK cells were fixed with 4% paraformaldehyde (Aldrich) dissolved in Dulbecco's Phosphate-Buffered Saline solution (PBS, Invitrogen) for 5 min and washed with PBS solution for 3 times. The samples were then stained with 0.5% Methyl green (Aldrich Chemicals) solution for 10 min followed by 3 washes with H₂O and allowed to dry in air. FIG. 4 shows bright field (FIGS. 4(a), (c)) and fluorescence (FIGS. 4(b), (d)) photographs of the resulting PDMS films, showing the cell attachment test results. The fluorescence microscope images were obtained using an Olympus BX 61 Fluorescence Microscope with internal Z-motor. FIGS. 4(a) and 4(b) show photographs of a non-etched control PDMS film, which was prepared identically to the film shown in FIGS. 4(c) and 4(d) (which were prepared as described in Embodiment 1) except that it was not etched with the HF solution. FIGS. 4(c) and 4(d) show photographs of a PDMS film prepared by spraying and etching the film in a 25% aqueous solution of HF for 10 minutes. As shown in the Figures, both the bright field and fluorescence microscope studies confirmed that there was little or no cell adhesion to the non-etched control films, but there was a significantly increased cell attachment on the PDMS films that had microstructures created thereon by HF etching.

### Embodiment 4

### Applicability to Non-Flat Surfaces

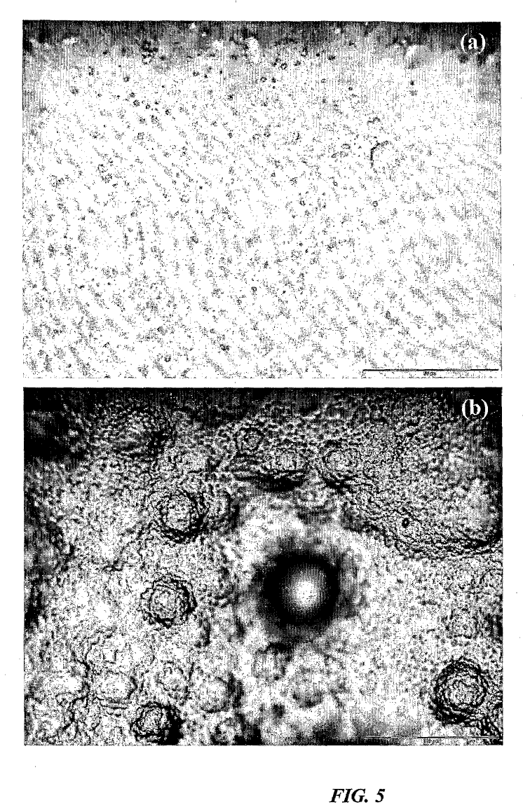

To test the applicability of the microdroplet patterning technique on a non-flat surface, a silicone tube with a diameter of 3 mm was sprayed and etched using the process of Embodiment 1. FIG. 5 shows bright field photographs of this silicone tube before (a) and after (b) processing using the microdroplet patterning technique. As shown in the Figure, a micro-textured surface was generated on the surface of the silicone tube.

### Embodiment 5

### Secondary Patterning Using a Mask

The present method may also be employed with conventional mask technology to add further levels of detail or regularity to the microstructures formed on the elastomeric surface. Specifically, a porous filter or screen placed between the sprayer and the sample can provide additional control over the pattern formed.

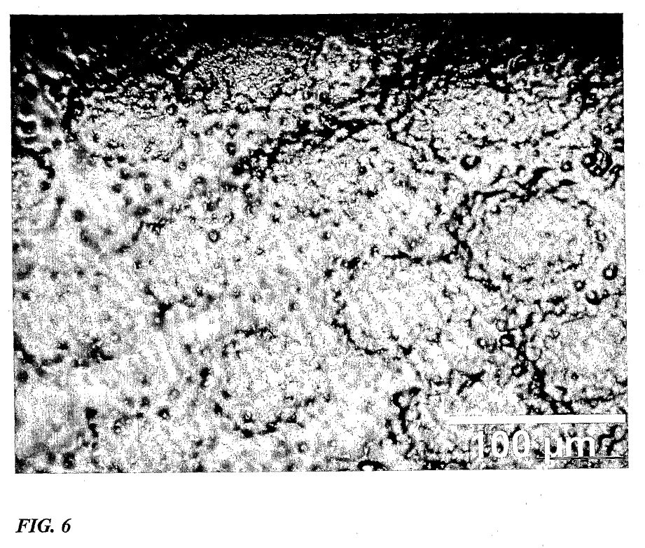

In this embodiment, a pattern of 50 μm-wide squares was generated on a PDMS film with a copper grid shadow mask (Ted Pella TEM grid) placed between the sprayer and the film, 2 mm away from the film. With the exception of the use of the mask, the protocol employed was the same as that described in Embodiment 1 above. FIG. 6 shows a bright field microscope image of a PDMS film with a pattern of 50 μm-wide squares generated using the copper grid shadow mask. As shown in the Figure, the elastomeric surface exhibits not only the pattern of the grid employed, but also the microfeatures introduced by the spraying, baking and etching steps. In this case, a grid-shaped mask was employed, but other shapes are contemplated. Specifically, it may be advantageous in certain applications to employ a mask that significantly reduces or eliminates microdroplet formation in certain areas, so as to achieve different microstructure characteristics and thereby affect cell adhesion in desired patterns.

What is claimed is:

1. A method of treating an elastomeric surface, comprising:
forming microdroplets of a liquid comprising a polymer on the elastomeric surface;
hardening the polymer microdroplets;
chemically etching the surface with an agent that etches the elastomer but does not etch the hardened polymer microdroplets; and
dissolving the polymer microdroplets.

2. The method of claim 1, wherein the elastomeric surface comprises a silicone elastomer.

3. The method of claim 1, wherein the elastomeric surface comprises polydimethylsiloxane.

4. The method of claim 1, wherein the liquid comprises polymers dissolved in propylene glycol monomethyl ether acetate.

5. The method of claim 1, wherein the forming step comprises spraying the liquid onto the elastomeric surface.

6. The method of claim 1, wherein the forming step comprises bringing an elongate probe that supplies the liquid into contact with the elastomeric surface.

7. The method of claim 1, wherein the hardening step comprises baking.

8. The method of claim 1, wherein the hardening step comprises exposing the microdroplets to radiation.

9. The method of claim 1, wherein the hardened microdroplets have a maximum width within a range of 0.001-500 microns.

10. The method of claim 1, wherein the hardened microdroplets have a maximum width within a range of 0.005-300 microns.

11. The method of claim 1, wherein the hardened microdroplets have a maximum width within a range of 0.05-175 microns.

12. The method of claim 1, wherein the hardened microdroplets have a maximum width within a range of 0.5-100 microns.

13. The method of claim 1, wherein the etching agent is an acid solution.

14. The method of claim 13, wherein the acid solution is an aqueous hydrofluoric acid solution.

15. The method of claim 13, wherein the acid solution is a nitric acid solution.

16. The method of claim 1, wherein the etching agent is an ionic species.

17. The method of claim 1, wherein the etching agent is oxygen plasma.

18. The method of claim 1, wherein the etching agent is selected from the group consisting of sodium hydroxide, acetone, toluene, and hexane.

19. The method of claim 1, wherein the dissolving step comprises rinsing with an agent that dissolves the polymer microdroplets.

20. The method of claim 19, wherein the rinsing agent is ethanol.

21. The method of claim 19, wherein the rinsing comprises ultrasonication in absolute ethanol.

22. The method of claim 1, additionally comprising rinsing the surface with water immediately after the etching step.

23. The method of claim 5, wherein the forming step comprises spraying the polymer solution onto the elastomeric surface through a shadow mask.

24. The method of claim 23, wherein the shadow mask has a grid shape.

25. The method of claim 23, wherein the shadow mask is configured to prevent formation of microdroplets on at least a portion of the elastomeric surface.

26. The method of claim 1, wherein the forming step comprises:
heating solid polymer microparticles to form the polymer microdroplets.

27. The method of claim 26, wherein the hardening step comprises cooling the microdroplets.
